(19) United States
(12) Patent Application Publication
(10) Pub. No.: US 2006/0062197 A1
(43) Pub. Date: Mar. 23, 2006

(54) Communications networks

(76) Inventors: Thomas Slade Maddern, Wimborne, Dorset (GB); Richard John Proctor, Dorset (GB)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 10/499,389

(22) PCT Filed: Dec. 16, 2002
(86) PCT No.: PCT/GB02/05702

§ 371 Date: May 24, 2005

(30) Foreign Application Priority Data
Dec. 21, 2001 (GB) 0130730.5

(51) Int. Cl. H04L 12/28

(52) U.S. Cl. 370/351

(57) ABSTRACT

A partially interconnected network has a plurality of nodes, which nodes include either Allocated Nodes and Star Nodes (STARs), wherein the Allocated Nodes are each allocated to one of a number of Areas (AREAs) and the partially interconnected network also comprises point-to-point interconnections between the Allocated Nodes and the STARs, where the number of AREAs with Allocated Nodes interconnected to an individual Star forms the number of Routes from an individual STAR, the Allocated Nodes of a first of the AREAs being interconnected to a set comprising some, but not all, of the STARs, and wherein further of the AREAs are similarly interconnected to further sets each comprising STARs and where there is at least one interconnection choice (Choice) between any two Allocated Nodes in different AREAs and where an interconnection route comprises two point-to-point interconnections interconnected in series by a STAR; or at least six Topological Nodes, each Topological Node having at least three point-to-point Topological Links connecting it to some, but not all, of the plurality of Topological Nodes and where there is at least one Choice of routing between any two Topological Nodes and where a Choice of routing comprises either two point-to-point Topological Links connected in series at another of the Topological Nodes or a direct point-to-point Topological Link between the two Topological Nodes, wherein at least one of the plurality of nodes includes a switch arranged to carry out a Simple Transit Core Function and three or more of the plurality of nodes include a Single Link Interface having associated Output Attributes and/or Input Cognizant Attributes.

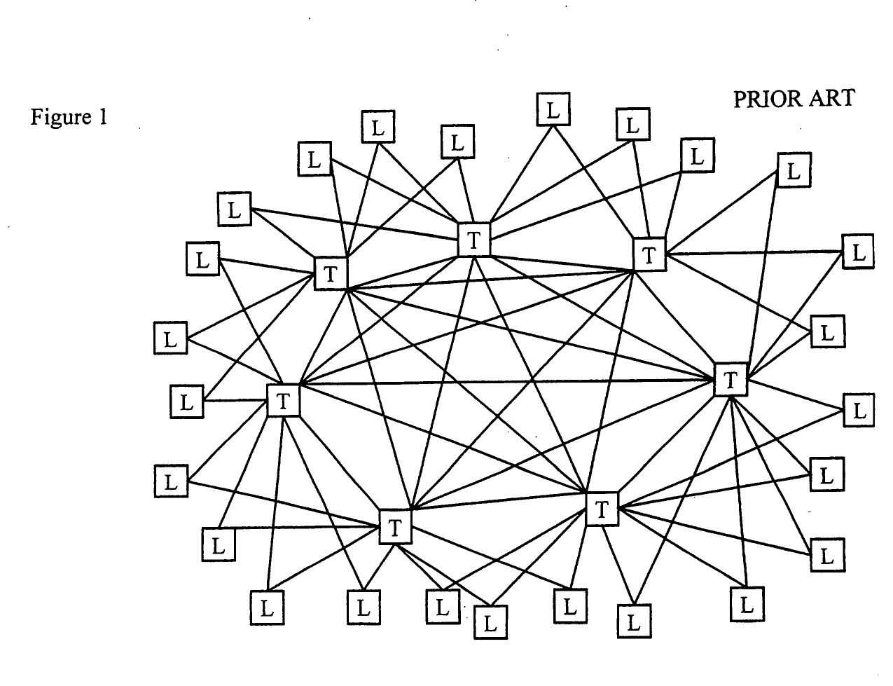

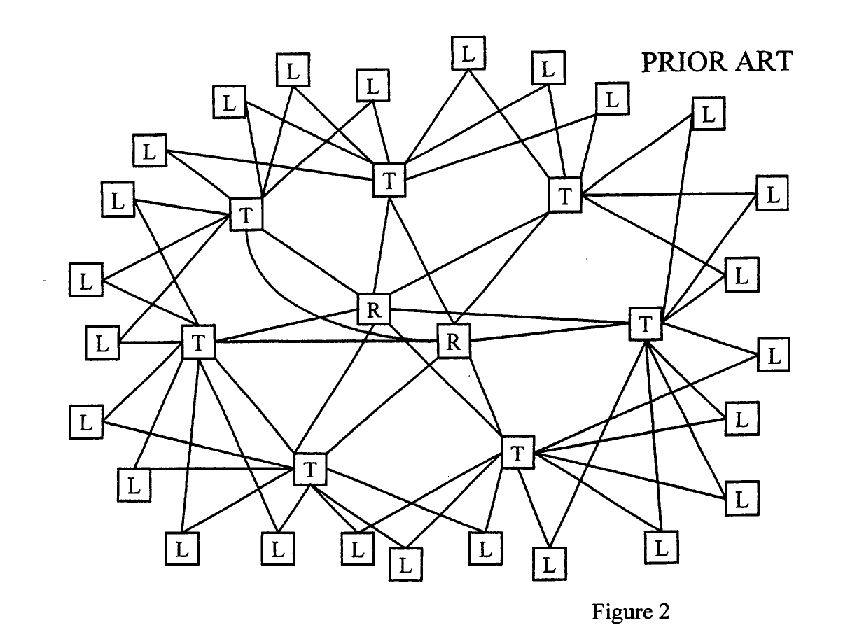

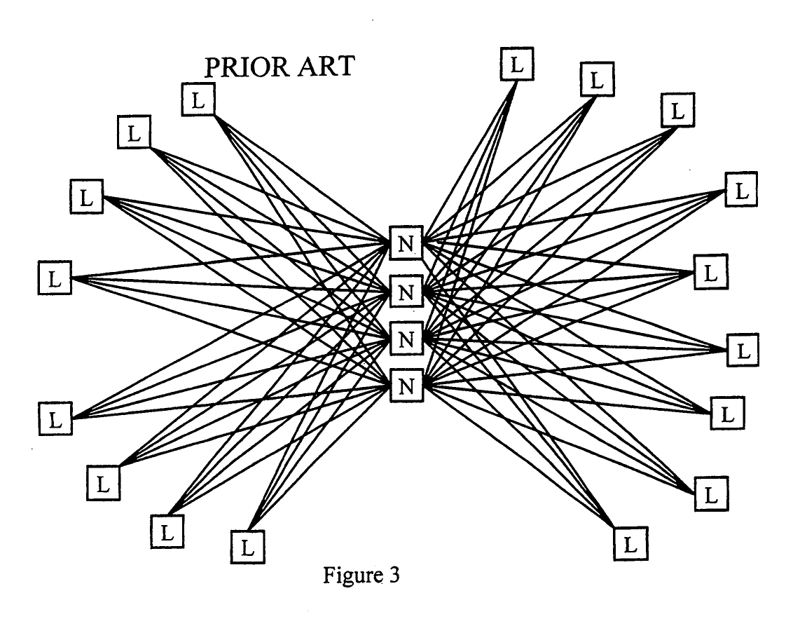

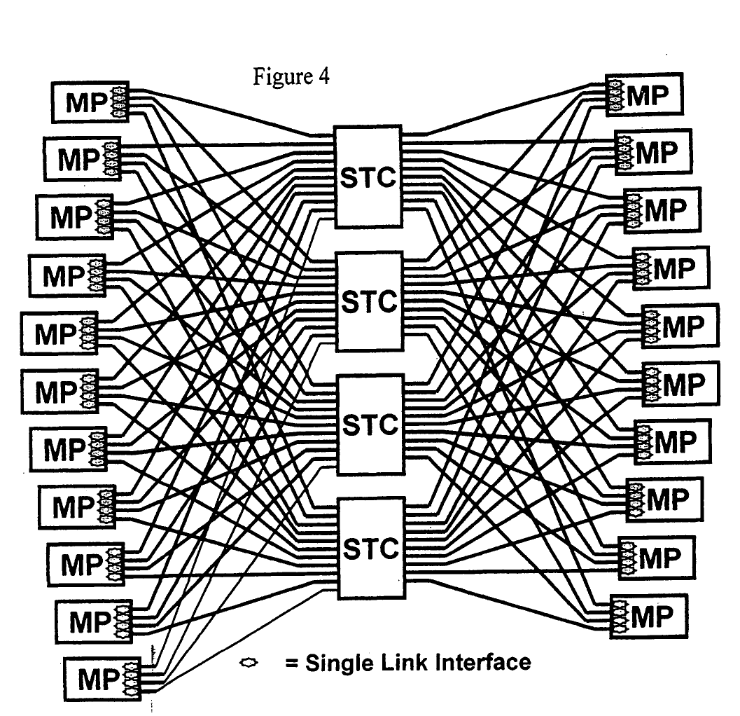

The PSTN Traffic Optimiser concept, as originally described in Patent Application No. GB2334408A, includes several figures, namely FIGS. 1, 2 and 4, which will be also be considered herein; and are included as FIGS. 1, 2 and 3 of the present invention. Similar figures are also included in Patent No. GB2343582B. Networks as typified by the core part of FIGS. 1 and 2 can be enhanced by the Partially Interconnected Network arrangements described in Patent Application No. WO 01/84877 herein described as Partially Interconnected FLAT Networks and networks as typified by FIG. 4 (FIG. 3 of the present invention) can be enhanced by the Partially Interconnected Network arrangements described in Patent No. GB2350517B herein described as Partially Interconnected STAR Networks. FIGS. 34, 46 and 47, from Patent No. GB2350517B, are include in the present invention as FIGS. 9, 6 and 7. The meanings of the terms AREA, STAR, ROUTE and CHOICE used in the present invention are based on the usage of these terms in Patent No. GB2350517B. Some figures included in this application have also been included in Patent Application No. GB0102349.8.

Patent Application No. GB 2334408A describes a telecommunications system comprising one or more cross-connects and a plurality of telephone exchanges, wherein two or more of the telephone exchanges are arranged to communicate with each other via the one or more cross-connects and an adapter for providing the telephone exchanges with a means of inter-communication via the one or more cross-connects wherein the adapter converts traffic between packetised and non-packetised form.

Patent No. GB 2343582B describes a telecommunications system comprising one or more cross-connects and a plurality of telephone exchanges, wherein two or more of the telephone exchanges are arranged to communicate with each other via one or more routers and an adapter converts traffic between packetised and non-packetised form.

Patent Application No. WO 01/84877 describes a partially interconnected topological network having at least six Topological Nodes, a Topological Node being a single Physical Node or a group of interconnected Physical Nodes or part of a Physical Node or a group of interconnected Physical Nodes and parts of Physical Nodes, each Topological Node having at least three point-to-point Topological Links connecting it to some but not all of the plurality of Topological Nodes and there being at least one Choice of routing between any two Topological Nodes, where a Choice of routing is either two point-to-point Topological Links connected in series at another of the Topological Nodes or a direct point-to-point Topological Link between the two Topological Nodes.

Patent No. GB2350517B describes a partially interconnected network having a plurality of Allocated Nodes, which Allocated Nodes are each allocated to one of a number of AREAs, and further has a plurality of Star Nodes (STARs), and also has point to point interconnections between the Allocated Nodes and the Star Nodes, where the number of AREAs with Allocated Nodes connected to an individual STAR forms the number of ROUTEs from an individual STAR, the Allocated Nodes of a first of the AREAs being connected to a set comprising some, but not all, of the Star Nodes, and further of the AREAs are similarly interconnected to further sets each comprising Star Nodes and there is at least one connection choice between any two Allocated Nodes in different AREAs and where a connection route is two point-to-point interconnections connected in series by a Star Node.

Patent Application No. GB0102349.8 describes a partially interconnected network having a plurality of Topological Nodes, each Topological Node having at least three direct point-to-point Topological Links connected to other Topological Nodes, each of a proportion of the plurality of Topological Nodes having connected thereat one of a group of Point-of Presence (PoP) Units, said group of PoP Units arranged to provide access to a selected service or services, one or more than one of each at least three direct point-to Point Topological Links from each Topological Node not having connected thereat one of a group of PoP Units connecting to one or more than one of the plurality of Topological Nodes having connected thereat one of the group of PoP Units, there being at least one Choice of routing between any two Topological Nodes, a Choice of routing being either via two Topological Links connected in series at another Topological Node or a direct point-to-point Topological Link between the two Topological Nodes.

Dial-up telecommunication networks cannot just be constructed from switching functions as they need considerable functionality to receive signalling from the subscribers to determine the connections that are required as well as considerable processing and inter-node signalling functionality to determine how the various switches in the network should be set in order to allow a call to be established in a satisfactory manner. Likewise data networks contain more than just raw switching. The level of processing and the level of switching at a node depends on the required operational characteristics of a network. The object of Patent Application No. GB2334408A could be summarised as minimising or even removing the need for any processing at the most central nodes so that large raw switching functions can be provided without the need for very large amounts of processing power at those nodes, for example for call processing and handling signalling in the case of dial-up telecommunication networks. The processing would be supplied at the other nodes in the network.

The use of a Simple Transit Core function will be further discussed as part of a patent application co-filed with this patent application, having our reference P/63507.gba, entitled “Communication Network” and describing a network having a plurality of nodes, wherein at least one of the plurality of nodes includes a switching means arranged to carry out a Simple Transit Core Function and three or more of the plurality of nodes include a Single Link Interface, which Single Link Interface has associated Output Attributes and/or Input Cognisant Attributes where each Simple Transit Core Function at one node is not logically connected to another Simple Transit Core Function at another node and each Simple Transit Core Function at one node is logically connected to at least three Single Link Interfaces at other nodes and wherein the nodes including Single Link Interfaces which are connected to one instance of a node arranged to carry out a Simple Transit Core Function are controlled by respective Intercommunicating Connection Acceptance Control Processes according to the respective Output Attributes and/or Input Cognisant Attributes.

According to the present invention there is provided a partially interconnected network comprising a plurality of nodes, which nodes include either;
(a) Allocated Nodes and Star Nodes (STARs), wherein the Allocated Nodes are each allocated to one of a number of Areas (AREAs) and the partially interconnected network also comprises point to point interconnections between the Allocated Nodes and the STARs, where the number of AREAs with Allocated Nodes interconnected to an individual Star forms the number of Routes (ROUTEs) from an individual STAR, the Allocated Nodes of a first of the AREAs being interconnected to a set comprising some, but not all, of the STAR Nodes, and wherein further of the AREAs are similarly interconnected to further sets each comprising STAR Nodes and where there is at least one interconnection choice (CHOICE) between any two Allocated Nodes in different AREAs and where an interconnection route comprises two point to point interconnections interconnected in series by a STAR Node; or
(b) at least six Topological Nodes, wherein a Topological Node is a single Physical Node or a group of interconnected Physical Nodes or part of a Physical Node or a group of interconnected Physical Nodes and parts of Physical Nodes, each Topological Node having at least three point-to-point Topological Links connecting it to some but not all of the plurality of Topological Nodes and where there is at least one Choice of routing between any two Topological Nodes and where a Choice of routing comprises either two point-to-point Topological Links connected in series at another of the Topological Nodes or a direct point-to-point Topological Link between the two Topological Nodes;
   wherein at least one of the plurality of nodes includes a switching means arranged to carry out a Simple Transit Core Function and three or more of the plurality of nodes include a Single Link Interface which Single Link Interface has associated Output Attributes and/or Input Cognisant Attributes where each Simple Transit Core Function at one node is not logically connected to another Simple Transit Core Function at another node and each Simple Transit Core Function at one node is logically connected to at least three Single Link Interfaces at other nodes and wherein the nodes including Single Link Interfaces which are connected to one instance of a node arranged to carry out a Simple Transit Core Function are controlled by respective Intercommunicating Connection Acceptance Control Processes according to the respective Output Attributes and/or Input Cognisant Attributes.

The present invention will now be described by way of example, with reference to the accompanying figures, in which:

FIG. 1 shows in block diagram form a typical, conventional, prior art, large telecommunications network;

FIG. 2 shows the network of FIG. 1 with cross-connects according to a prior art invention;

FIG. 3 shows in block diagram form a typical, conventional, prior art, small telecommunications network;.

FIG. 4 shows a modified version of FIG. 3;

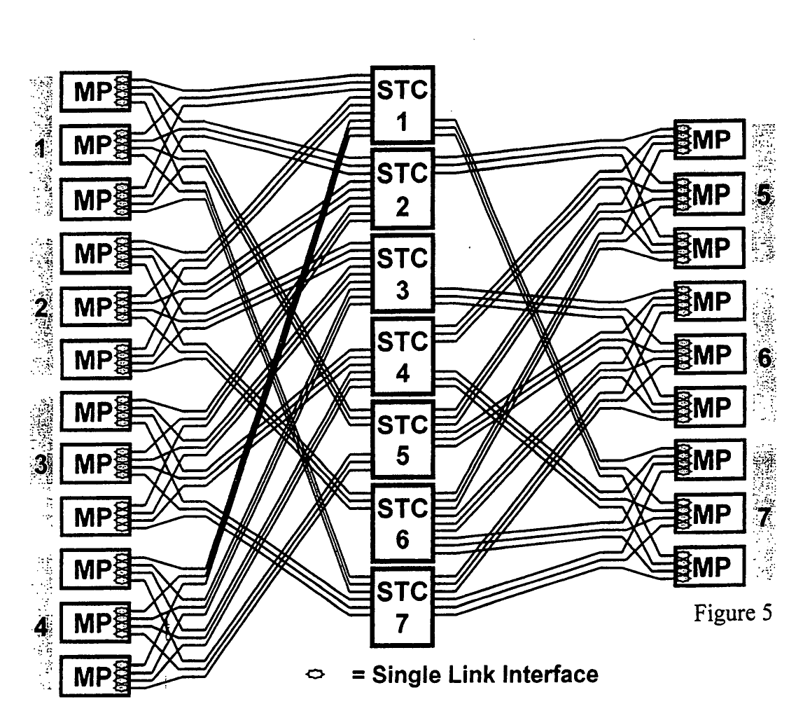

FIG. 5 shows a further modified version of FIG. 3;

FIG. 6 shows a prior art interconnection pattern for 21 Local NODEs;.

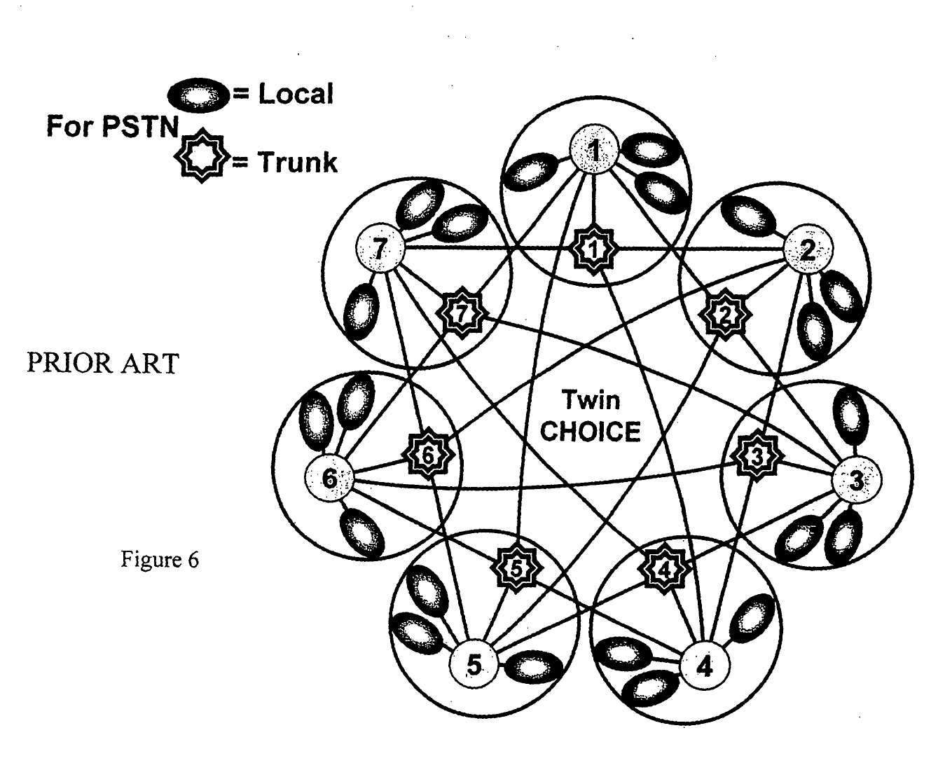

FIG. 7 shows the detail of AREA 4 of prior art FIG. 6;

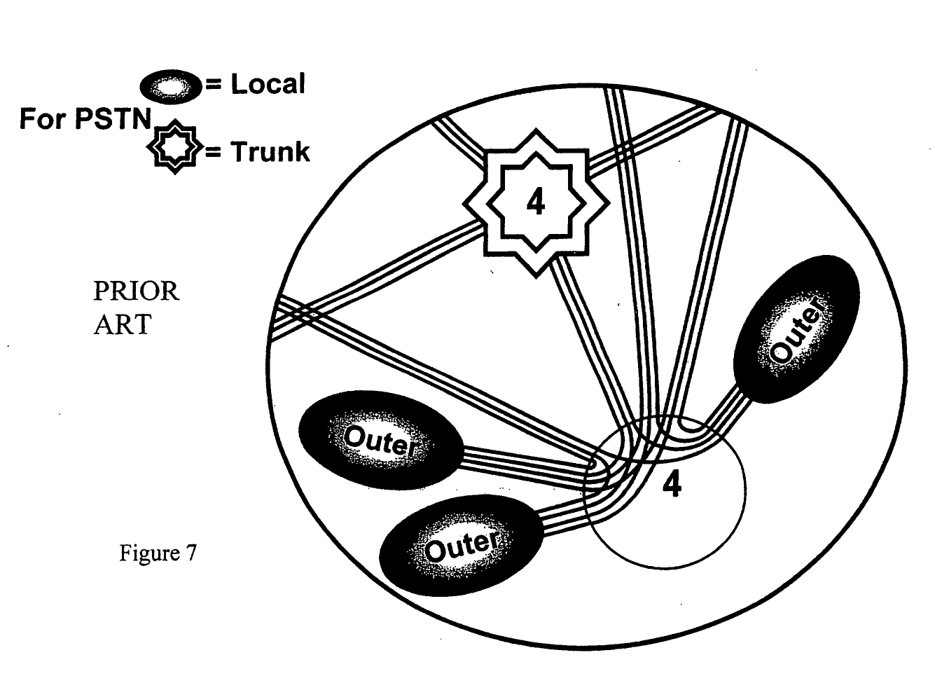

FIG. 8 shows a simplified connectivity of 7 STAR and 7 AREAs together with a connectivity table;

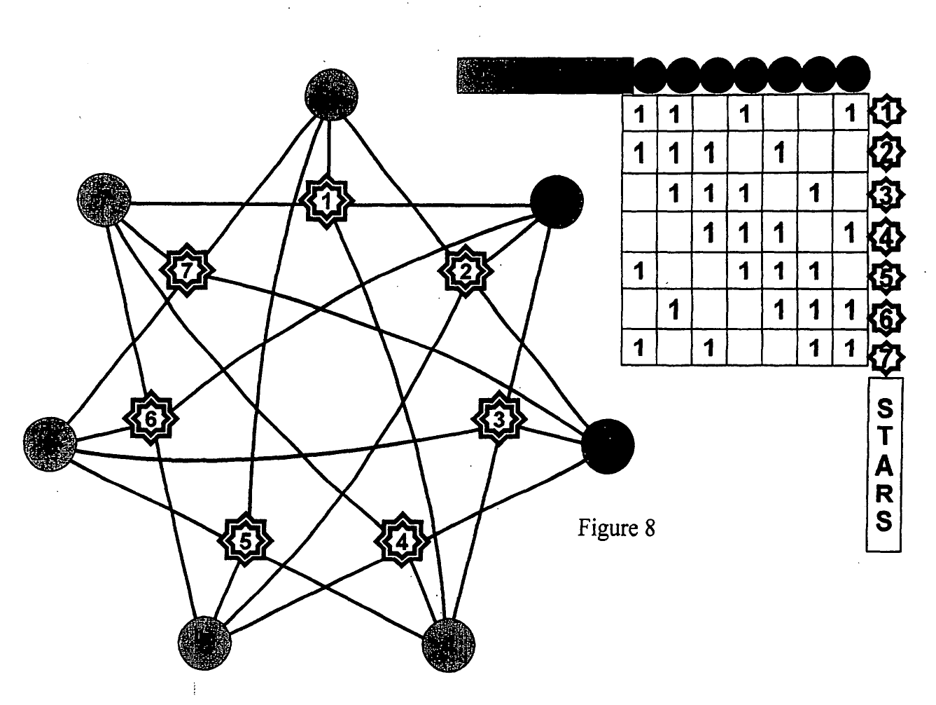

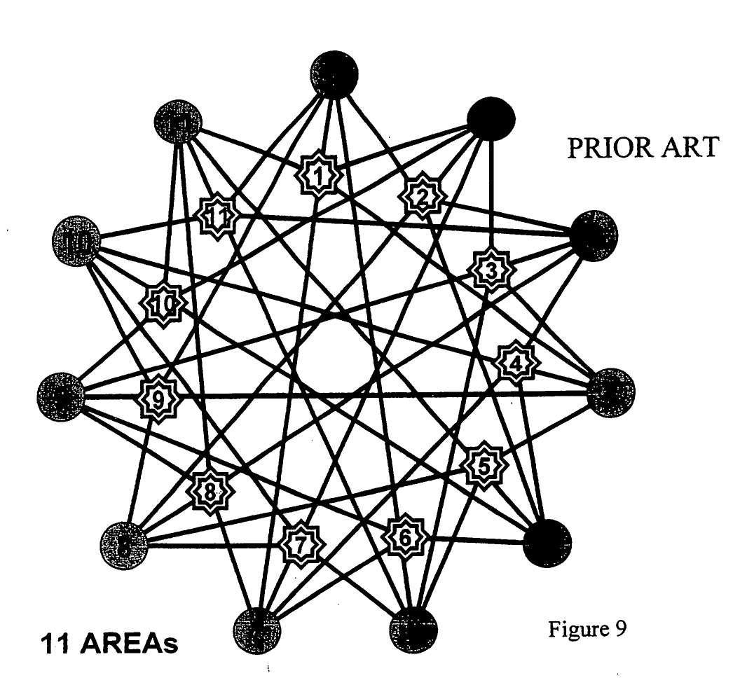

FIG. 9 shows a prior art Partially Interconnected Network having 11 AREAs and 11 off 5-pointed STARs;.

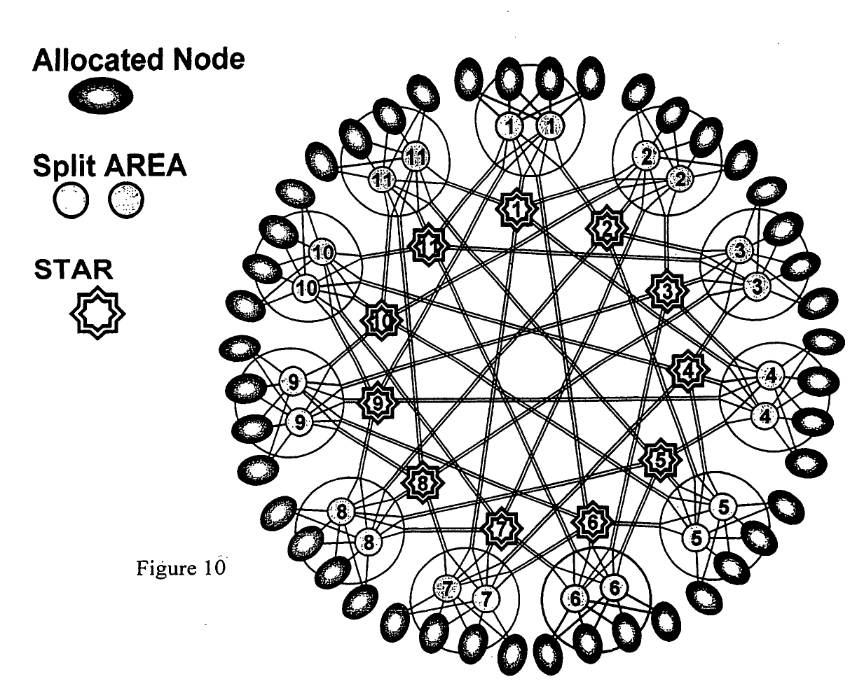

FIG. 10 is an example where the allocated edge nodes or local exchanges in each AREA are each connected via two Split AREA sites;

FIG. 11 shows a network having 7 separate nodes which are fully meshed;

FIG. 12 shows a smaller fully meshed network;.

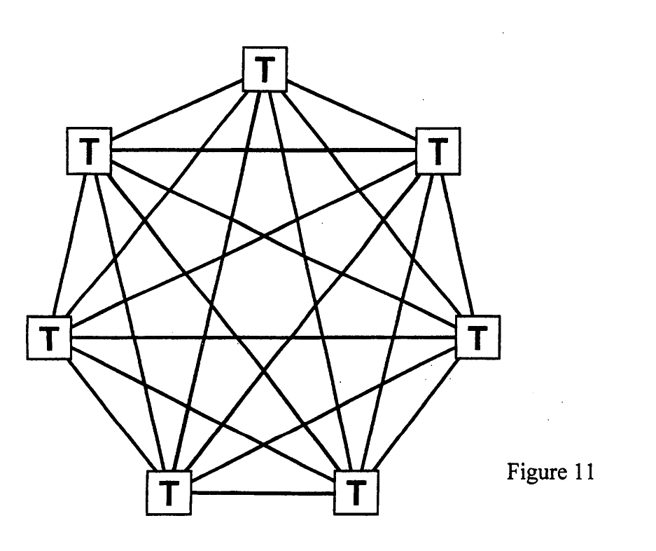

FIG. 13 shows Node A having direct connections to Nodes A, B and C;

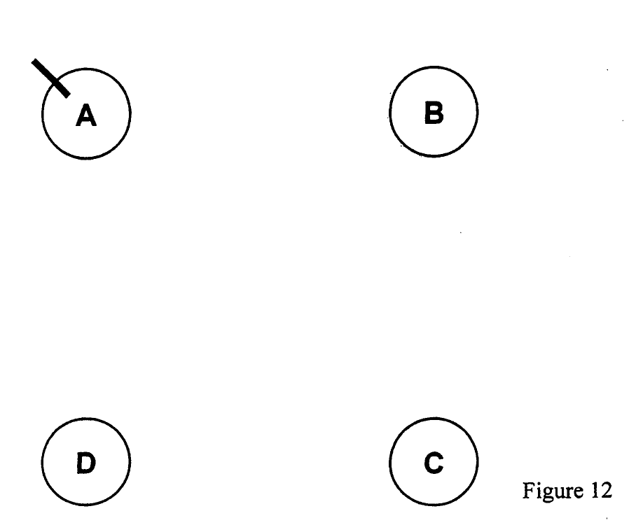

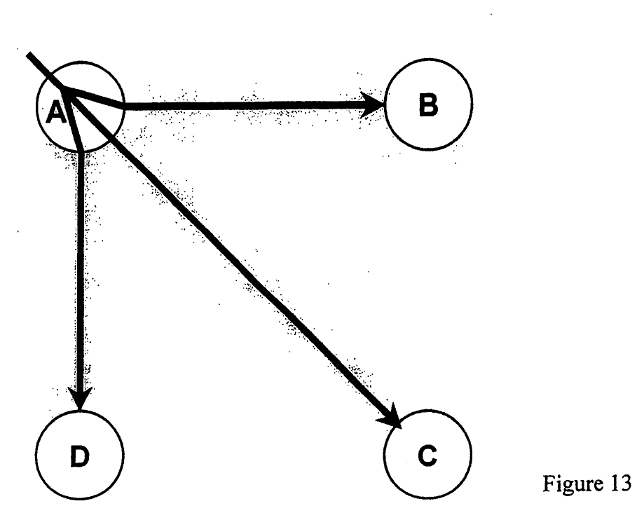

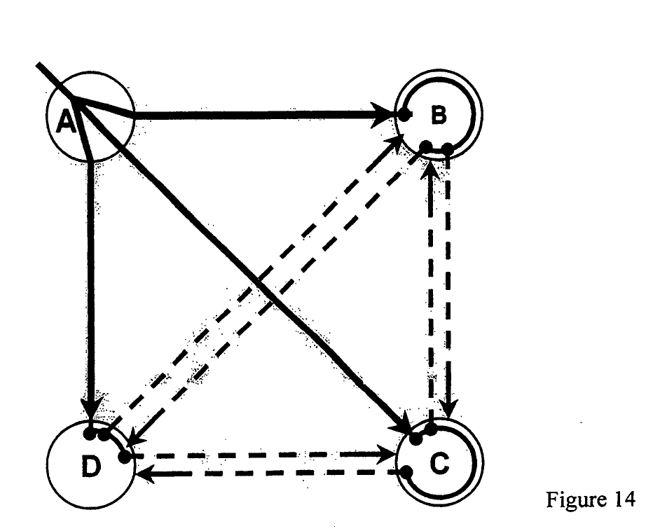

FIG. 14 shows a 4 Node example with alternative connections between the Nodes;

FIG. 15 a further 4 Node example with alternative connections between the Nodes;.

FIG. 16 example having 10 nodes where each node is connected to 3 others;

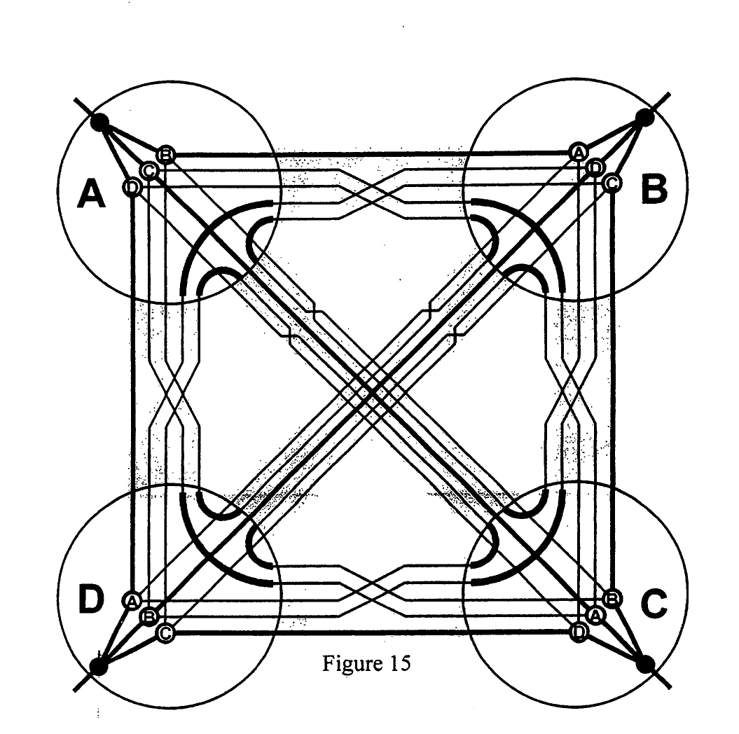

FIG. 17 is also an example which has 10 nodes, but each node is connected to 6 others;

FIG. 18 shows indirect two hop CHOICEs where there is no direct path;.

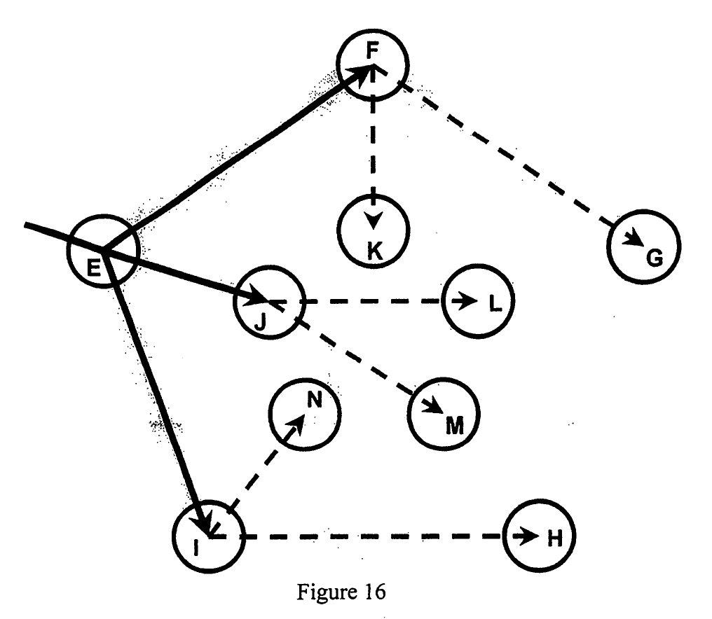

FIG. 19 shows indirect two hop CHOICEs where there is also a direct path;

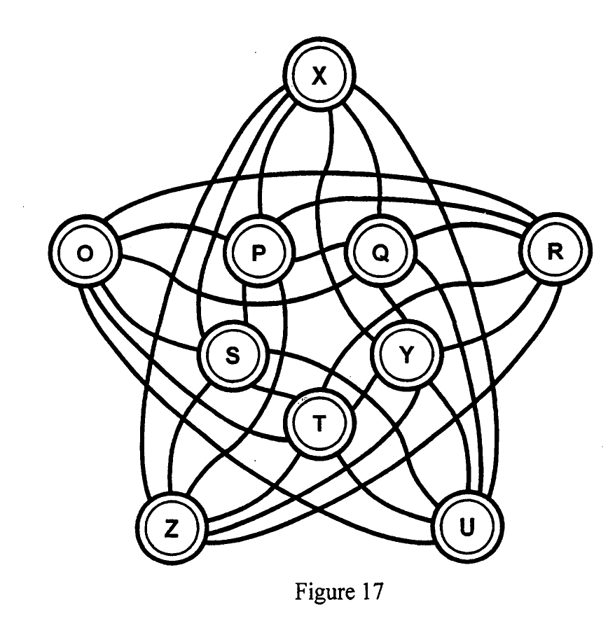

FIG. 20 is the same network as shown in FIGS. 17 to 19 except that the five meshes have been replaced by 5 Point Mesh nodes;

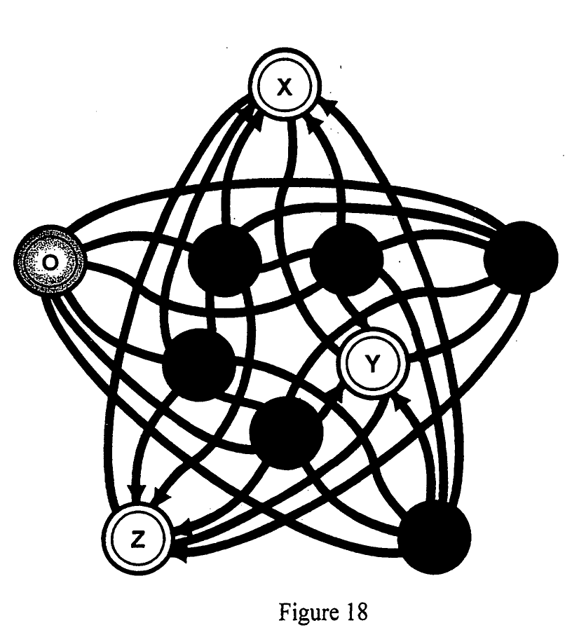

FIG. 21 is a redrawn version of FIG. 20;.

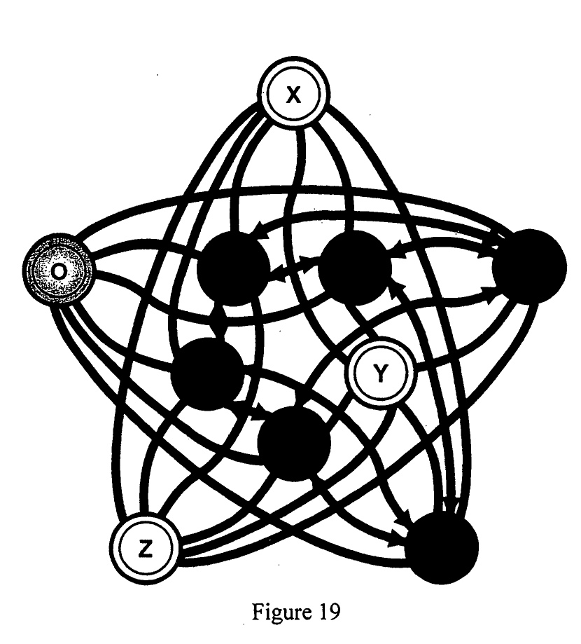

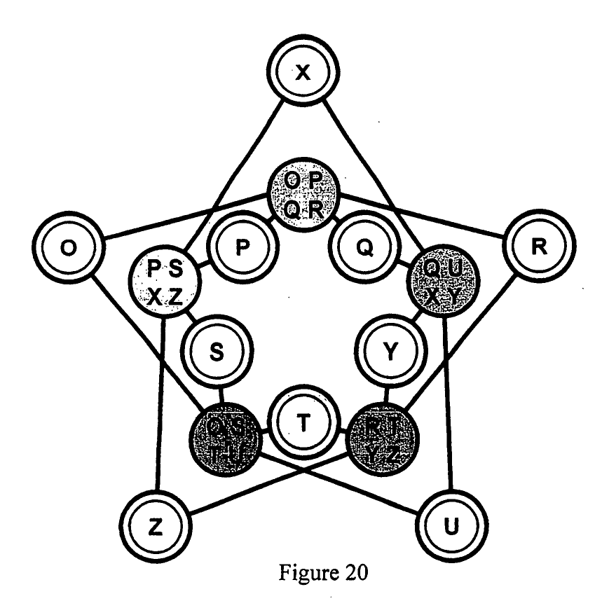

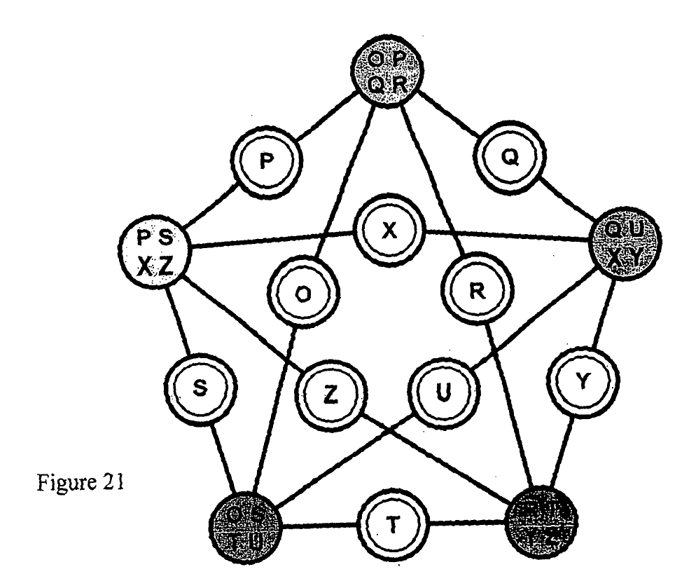

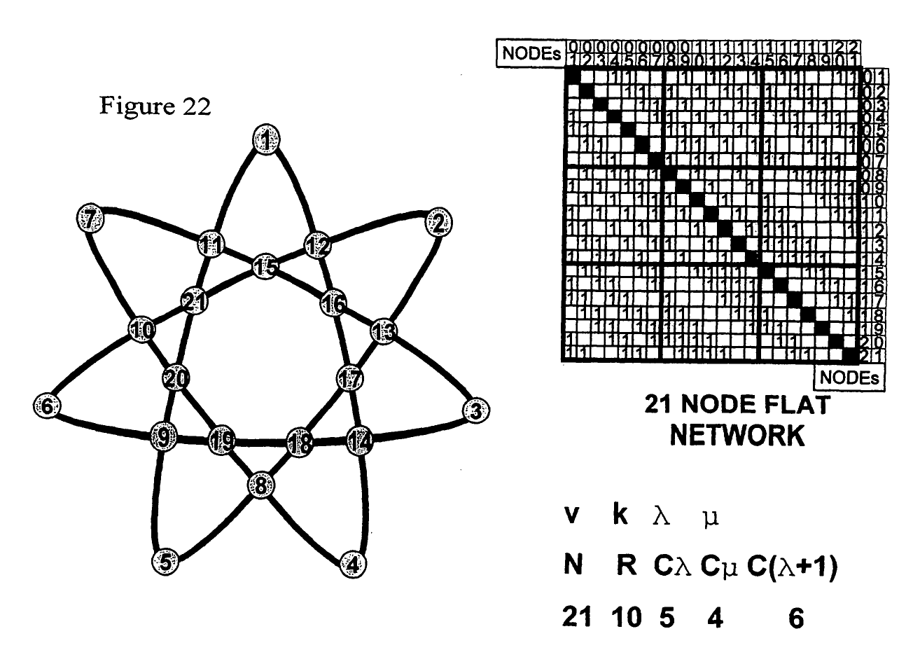

FIG. 22 shows a larger form of the style of network shown in FIGS. 17 to 19;

FIG. 23 shows an example with 7 meshes as 7 Point Meshes, with each node connected to 2 Point Meshes;

FIG. 24 shows an example formed from 8 meshes each of 4 Nodes: 4 horizontal and 4 vertical;.

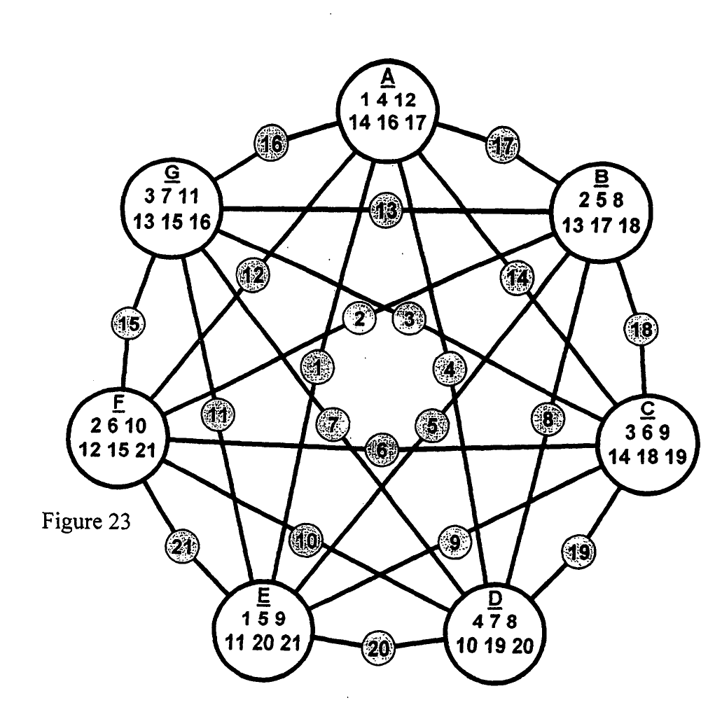

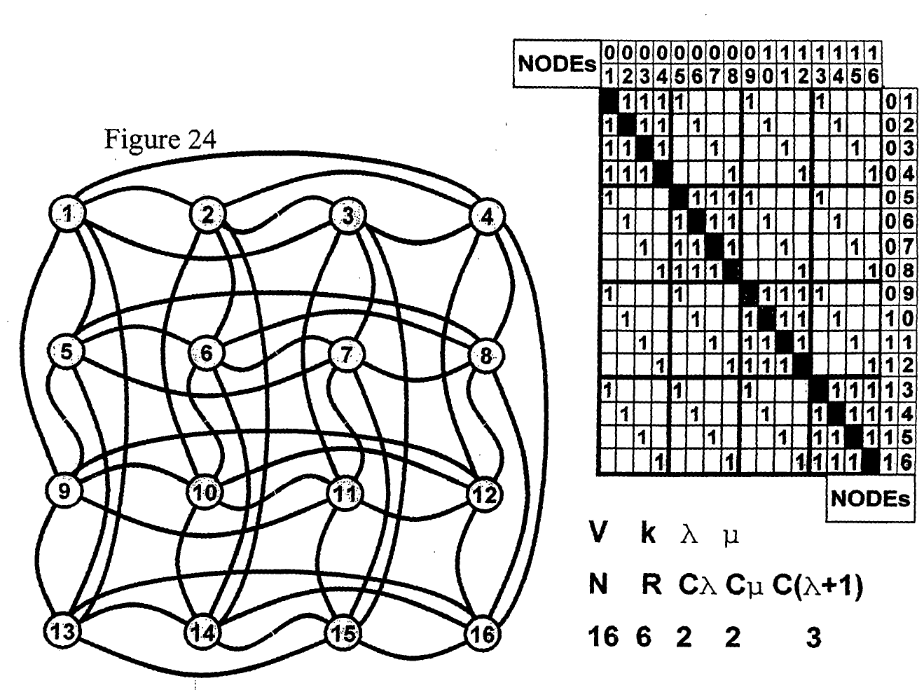

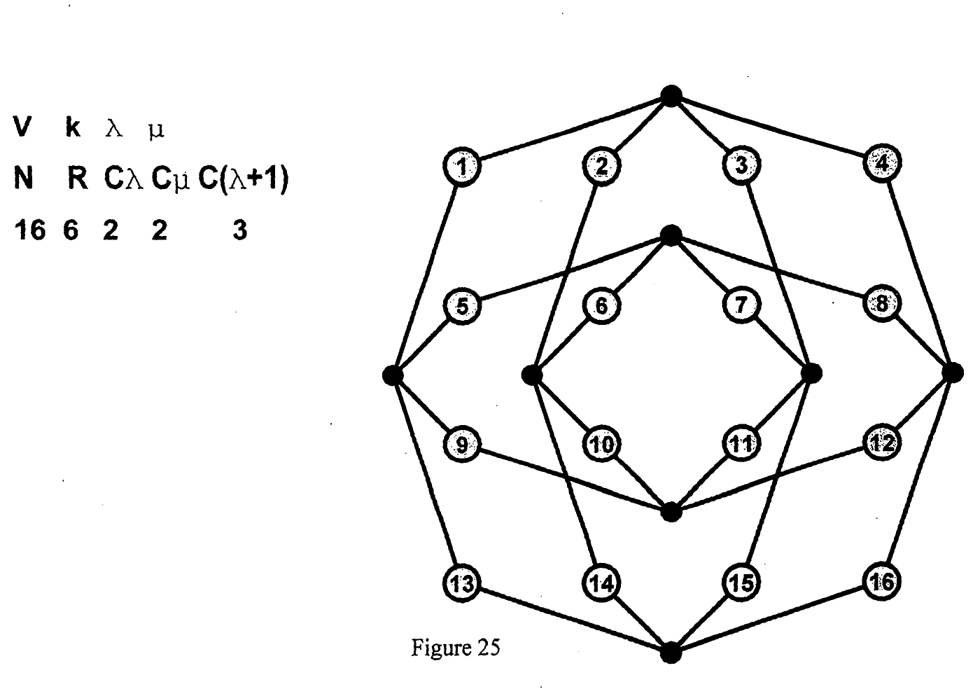

FIG. 25 shows the example of FIG. 24 with the 8 meshes as Point Meshes, with each node connected to just 2 Point Meshes;

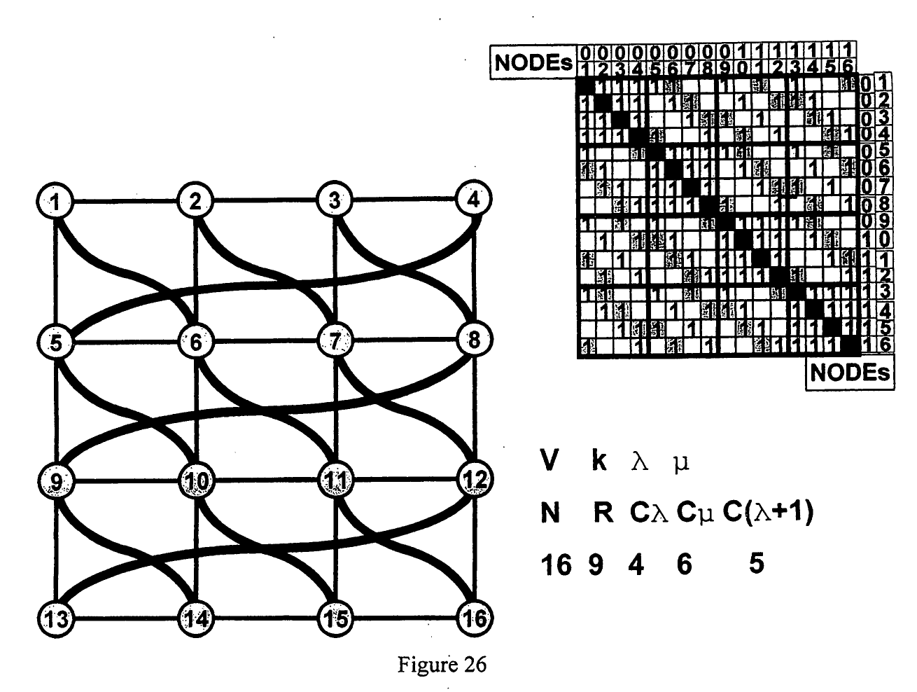

FIG. 26 shows a more heavily interconnected network;.

FIG. 27 shows the network of FIG. 26 drawn with Point Meshes instead of lines;

FIG. 28 shows the four ways of establishing an indirect path from Node 1 to Node 2 in FIG. 23;

FIG. 29 shows the effect of an unavailable Point Mesh in FIG. 23.

For the purposes of the present invention the term Simple Transit Core (STC) function will be used to describe a function that may be included at some, or all, of the nodes of a network. Another term that will be used is Single Link Interface which may be included, or multiple instants may be included, at some, or all, of the nodes of a network. Single Link Interfaces have to be controlled and the term that will be used is Intercommunicating Connection Acceptance Control Process.

In order to simplify the description it will be generally assumed for this patent application that the there will be nodes which are the Main Processing (MP) nodes and these nodes will intercommunicate with other Main Processing (MP) nodes to perform the Intercommunicating Connection Acceptance Control Processes for all the Single Link Interfaces connected to a Simple Transit Core (STC) function. A Simple Transit Core (STC) function is basically a large switch, router or crossconnect which needs much less relative processing power than a Main Processing (UT) Node.

FIG. 4 of Patent Application No. GB2334408A (FIG. 3 of the current patent application) shows four core nodes labelled N each connected to many nodes labelled L. A similar figure is included as FIG. 4, with the four core nodes labelled STC; and the other nodes, where most of the processing occurs, labelled as MP representing the main processing nodes and include Single Link Interfaces for each link to an STC node. Assuming that such a network allows for the failure of one of the STC nodes, then the network can carry up to three times the capacity of one of the STC nodes. To double the capacity would require three further STC nodes to be added. This would require all the MP nodes to have seven interfaces instead of four and would result in there being seven alternative paths through the network instead of four.

FIG. 5 has the same number of MP nodes as FIG. 4, but it has seven STC nodes. However the MP nodes are still only connected to four of the STC nodes. Whereas in FIG. 4 the STC nodes had connections to twenty-one ports in FIG. 5 they only have connections to twelve ports.

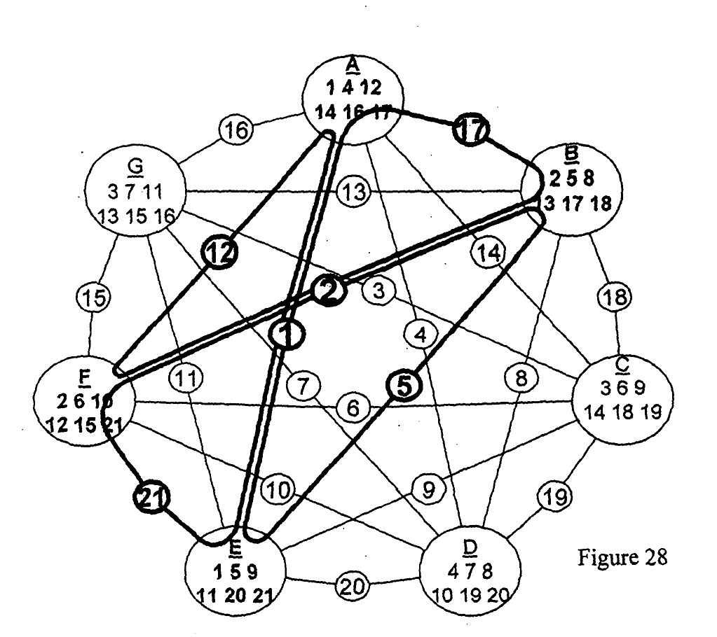

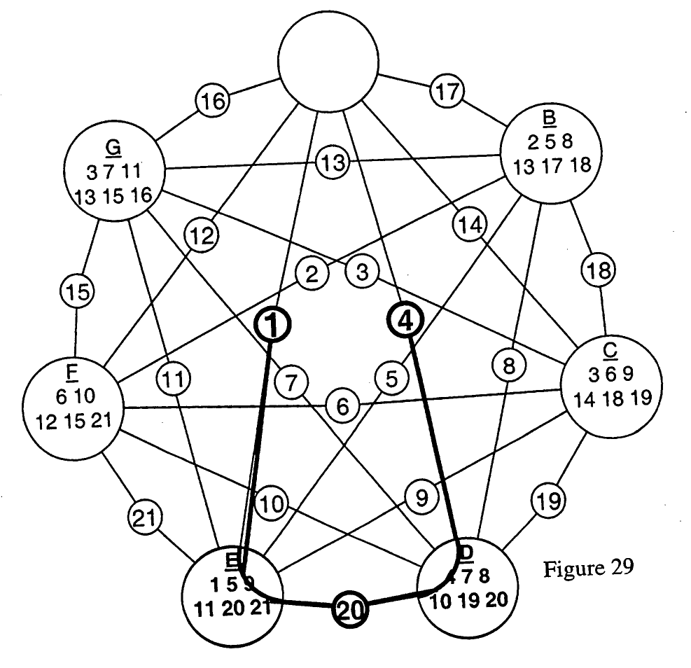

FIG. 6 is the same as FIG. 46 in Patent No. GB2350517B and FIG. 7 is the same as FIG. 47 in Patent No. GB2350517B. These figures show seven STARs connected to seven AREAs with three allocated nodes to each AREA. The topology of FIG. 6, when the detail of the FIG. 7 is included, happens to directly correspond to that shown in FIG. 5.

The seven STC nodes correspond to the seven STARs. The seven groups of MP nodes correspond to the seven AREAs and the twenty-one MP nodes correspond to the twenty-one Allocated nodes (Locals).

Each STAR is connected to four AREAs and in Patent No. GB2350517B this is described as a STAR having four ROUTEs.

FIG. 8 shows the simplified connectivity of seven STARs and seven AREAs along with the connectivity table. The characteristic of this table is that it demonstrates that there are two CHOICEs for traversing from one AREA to another AREA via a STAR. The connectivity table was included in patent GB2350517B as a Twin CHOICE pattern.

As already mentioned the failure of a STC node for the network shown in FIG. 4, reduces the capacity of the network, but this does not lead to connections not being able to be established. Similarly, for the twin CHOICE Partially Interconnected STAR Network described in FIGS. 5, 6, 7 and 8, the loss of one of the STAR nodes means that the traffic can be spread across the other six STARs. This concept was mentioned in Patent No. GB2350517B.

Analysing the possibilities of the example Partially Interconnected STAR Network shown in FIGS. 5, 6 and 7, the STAR/ STC nodes are only using twelve of the ports out of the twenty-one ports employed in FIG. 4. If each AREA had five local or MP nodes then the network would contain thirty-five local or MP nodes and still only use twenty ports on each STAR or STC node. This clearly enables much larger networks to be constructed from nodes that have finite capacity. A limitation was implied in Patent Application No. GB2334408A when it stated that FIG. 4 showed a typical smaller network (FIG. 3 of the current patent application). By combining the PSTN Traffic Optimiser concept as described in Patent Application No. GB2334408A for using Simple Transit Core Nodes with large switches with the Partially Interconnected STAR Networks as described in Patent No. GB2350517B, then much larger and more efficient networks can be achieved, than envisaged by Patent Application No. GB2334408A.

The fact that the network is only twin CHOICE compared with the four CHOICES of the network shown in FIG. 4, is also a significant benefit. For a network that has thirty-seven STAR or STC nodes, having thirty-seven CHOICEs of forwarding through the network is becoming a considerable problem and requires each MP node to be connected to thirty-seven STC nodes. Yet, the network mentioned in patent GB2350517B and shown in FIG. 48 of that patent, with the rotational pattern mentioned in FIG. 11, of that patent, would constrain the number of CHOICEs to being exactly two. The number of ROUTEs (the number of AREAs to which a STAR is connected) in this example being nine.

One of the benefits of STAR Networks is restricting the number of CHOICEs to a more manageable level. In a network as described in the original PSTN Traffic Optimiser Patent Application No. GB2334498A where all the Local or MP nodes are fully connected to all the STC or STAR nodes; if there are one hundred and seventy-five STC or STAR nodes, then there are one hundred and seventy-five CHOICEs for getting from one MP or Local Node to another MP or Local Node.

PTO requires a signalling, or bearer control means between all the MP or Local nodes. This is to enable the Intercommunicating Connection Acceptance Control Processes to act upon the associated Output Attributes and the Input Cognisant Attributes of the Single Link Interfaces. Hence there are one hundred and seventy-five ways of passing the signalling forward, assuming that the signalling is addressed using VPI's (Virtual Path Indicators) via STC nodes, and that the STC Nodes are large ATM Core switches. For seven thousand separately addressed MP or Locals and one hundred and seventy-five fully connected Core ATM Switches: seven thousand different VPI's signalling paths and routes have to be handled on each interface. Unfortunately ATM has a limit of four thousand and ninety-six VPI (Virtual Path Indicator) addresses.

By using a five CHOICE pattern with one hundred and seventy-five STC STAR ATM Switches and one hundred and seventy-five AREAs; with each AREA having on average forty Allocated MP or Local Nodes, then the number of VPI's required drops to forty times thirty, namely one thousand one hundred and sixty, where thirty is the number of AREAs to which a STAR is connected. This is then within the four thousand and ninety-six limit. The CHOICEs drops from one hundred and seventy-five to five and the number of cabled paths drops by over 80% and they are correspondingly much broader.

The concept of having large core switching nodes with Reduced Processing, whether these switches are ATM, IP, MPLS or any type of packet switching or circuit switches, for example 64 kbit/s switches, enables effective networks to be constructed, but the size of practical networks that can be built can be increased considerably by using Partially Interconnected STAR Network topologies as listed in patent GB2350517B and those formed from Balanced Incomplete Block Designs.

For a practical network it is not only necessary to have a sound theoretical architecture, but also it is useful if it can be made to fit into a simple infrastructure arrangement for example with a minimum number of physical ducts, and still achieve a high level of availability.

FIG. 9 which corresponds to FIG. 34 of Patent No. GB2350517B is a theoretical architecture.

FIG. 10 is a practical realisation using the theoretical architecture of FIG. 9, where all the many allocated edge nodes or local exchanges in each AREA are each connected via two Split AREA sites, probably containing crossconnects, to the five STARs, in a similar way to that shown in FIGS. 6 & 7.

This enables a network to be constructed, where each allocated node is physically connected to just two Split AREA sites and each STAR is only connected to ten Split AREA Sites. The STARs can be Simple Transit Core (STC) nodes.

The same basic topology can also be operated in a completely different way. Referring to FIG. 10, the STARs could be Main Processing (MP) nodes as well as the Allocated Nodes and all the Split AREA sites could contain Simple Transit Core (STC) nodes. Provided each STC node is accessed from MP nodes then this is also a workable arrangement. This will be mentioned again later.

“The CRC Handbook of Combinatorial Design”, C. J. Colbourn and J. H. Dinitz (Eds.), CRC Press, Boca Raton, Fla., 1966: lists Balanced Incomplete Block Designs which are Symmetric Designs (Table 5.7 on page 80) and Abelian Difference Sets (Table 12.4 page 301, using terms (v, k, λ) which can be used to define constant CHOICE (λ) Partially Interconnected STAR Networks with AREAs equal to STARs (v) and ROUTEs (k);.

The Balanced Incomplete Block Designs where the number of AREAs is not equal to the number STARs can also be used as Partially Interconnected STAR Networks a comprehensive list can also be found in the above mentioned “The CRC Handbook of Combinatorial Design” 1.3 Parameter Tables page 14, where (v) is AREAs; (b) is STARs; (k) is ROUTEs; (λ) is CHOICEs and (r) equals the number of STARs to which an AREA is connected.

The converse of these Balanced Incomplete Block Designs (where each connection is replaced by a non-connection and each non-connection is replaced by a connection) can also sometimes be suitable.

A characteristic of Partially Interconnected STAR Networks as described by Patent No. GB2350517B is that regular patterns with a constant CHOICE do not exist for AREAs being greater than the number of STARs. Hence when considering FIG. 2 of Patent Application No. GB2334408A (FIG. 2 of the present invention) a straight forward substitution is not obvious. For a larger example it would be possible to group the nodes labelled T into several AREAs and then have the same number of STARS as AREAs.

However, there is an alternative approach which can take advantage from the concept of a Simple Transit Core (STC) node which has a large switch, but only needs a small amount of processing. This alternative approach could combined a Simple Transit Core (STC) node with a Main Processing (MP) Node which needs a large amount of processing, but only needs a moderate size switch. The combined use of the PTO concept and the Partially Interconnected FLAT Network topologies enables just such an arrangement. This arrangement could be used for just part of a network (e.g. the core or a network) or a complete network. In order to simplify the explanation the numbers of nodes used in the initial examples will be small. Patent Application No. GB2334408A describes this Simple Transit Core function as a cross-connect.

FIG. 1 of Patent Application No. GB2334408A shows seven nodes labelled T where each such node is directly connected to the other six nodes labelled T. FIG. 11 of the present invention shows the same interconnection arrangement between seven nodes labelled T. FIG. 11 shows just the seven separate nodes which are fully meshed.

FIG. 12 shows a smaller fully meshed network. Fully meshed networks have several disadvantages, some of which are described in the referenced patents. FIG. 13 shows Node A having direct connections to Nodes A, B and C. One disadvantage is when a link between a pair of nodes is overloaded or unavailable, it is not possible to directly communicate between that pair of nodes. It is of course possible to achieve communications between that pair of nodes, provided the communications can be passed via another node in the network. However that can mean considerable extra network capabilities in order to enable this to happen. It would be much easier if the communications could be forwarded using a Simple Transit function, such as the Simple Transit function described in Patent Application No. GB2334408A. FIG. 14 shows a four Node example of such an arrangement with Node A not only being able to directly reach the other three Nodes, but also to have two ways of indirectly reaching the other nodes, by transiting via another node. FIG. 15 shows, for a four node mesh network, all the direct one hop and indirect two hop possibilities for traversing between any pair of nodes, where the two hop possibilities transit via another node. Each of the four nodes in FIG. 15 is connected to three other nodes, which happens to be all the other nodes. The number of other nodes a node is connected to is known as ROUTEs.

In the rather complex FIG. 15 considering it is only representing a four Node Network, all the decision making at Node A is done by deciding whether to go to B, C, or D, and then via which route. The Simple Transit Core function is conceptually just a “nailed up pipe”. Of course when using switches which switch: cells, packets or frames, then the bandwidth of the “nailed up pipes” can be varied without changing the switch routing tables.

In this example each node is a combination of the Main Processing (MP) Function (which includes Single Link Interfaces and Intercommunicating Connection Acceptance Control Processes) and a Simple Transit Core (STC) Function at the same Node.

FIG. 16 also has each node connected to three other nodes, but in this example there are a total of ten nodes. Node E is directly connected to nodes F, J and I and by:transiting via node F then nodes G and K can be reached;

transiting via node J then nodes L and M can be reached;

transiting via node I then nodes N and H can be reached.

Hence node E is connected to all the other nodes either via a direct one hop path or via an indirect two hop path, transiting via another node. There is only one CHOICE of path to any Node.

FIG. 16 is a regular network and it follows that there is just one path between any node and any other node, where a path is either a direct one hop path or an indirect two hop path. This example has ten nodes where each node is connected to three others.

FIG. 17 is also an example which has ten nodes, but each node is connected to six others.

FIG. 18 shows that there are four CHOICEs of path from Node O to node X via nodes P, Q, S or U, as well as four CHOICEs of path to nodes Y and Z, where a path is an indirect two hop path, transiting via another node.

FIG. 19 shows that there are also four CHOICEs of path form node O to nodes P, Q, R, S, T and U. There is a direct path from node O to node P and there are three indirect paths transiting via nodes R, Q, or S.

Again, as this is a regular network then similar CHOICEs of paths exist between pairs of nodes.

Two examples of Partially Connected networks have been described in FIGS. 16 and FIGS. 17 to 19.

These are both examples of Strongly Regular Graphs. “The CRC Handbook of Combinatorial Design”, C. J. Colbourn and J. H. Dinitz (Eds.), CRC Press, Boca Raton, Fla., 1966: lists many possible Strongly Regular Graphs, under 5.9 Table on pages 671-683. In this handbook the Notation used corresponds as follows:

| | |
|---|---|
| v equates to N | The number of nodes in the network |
| k equates to R | The number of ROUTEs from a node |
| 8 equates to C8 | The number of CHOICEs of two hop paths between |
| | nodes where there is also a direct path between those |
| | nodes. |
| : equates to C: | The number of CHOICEs of two hop paths between |
| | nodes where there is no direct path between those nodes. |
| C(8 + 1) | The Total number of CHOICEs of two hop paths or a |
| | direct path between nodes where there is also a direct |
| | path between those nodes. |

| | | |
|---|---|---|
| For | | FIGS. 17 to 19 |
| v and N | =10 | =10 |
| k and R | =3 | =6 |
| 8 and C8 | =0 | =3 |
| : and C: | =1 | =4 |
| C(8+1) | =1 | =4 |

For both these examples the effective CHOICE is the same {C8 and C(8+1) but this is not the case for all Strongly Regular Graphs.

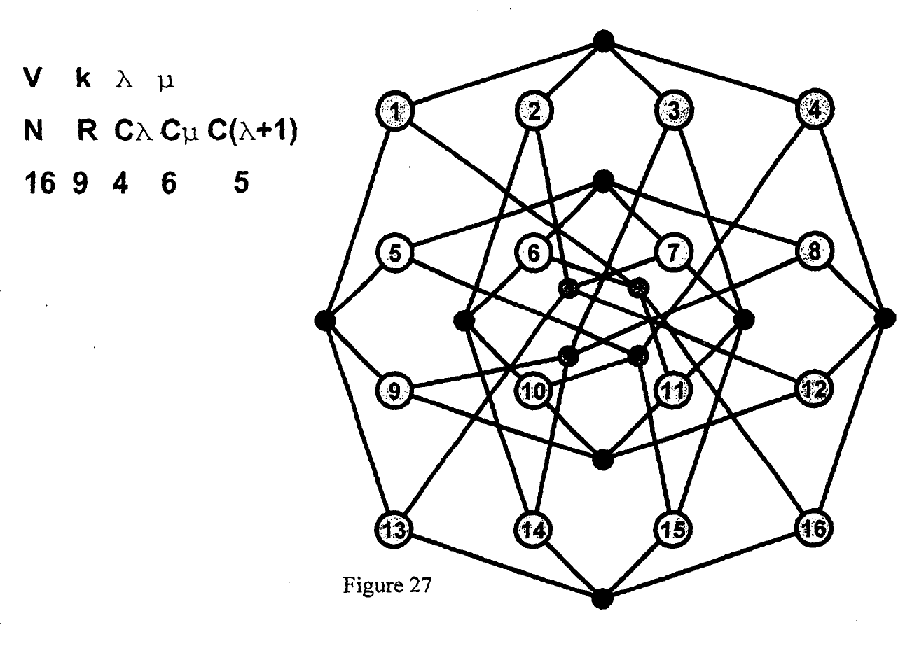

FIG. 20 is basically the same network as shown in FIGS. 17 to 19 except that the five meshes have been replaced by five Point Mesh nodes labelled: OPQR; QUXY; RTYZ; OSTU; PSXZ. Each, of the original 10 Nodes, is connected to two of the Point Mesh nodes. A Mesh can be implemented a number of distributed ways: using multiple connections within a transmission ring: using Optical Wavestars (See FIGS. 35 and 36 of the Partially Interconnected STAR Networks Patent GB23505 17B), or it can also be formed at a node from a switch, for example a crossconnect. A mesh can also be formed from a combination of these methods. FIG. 21 is a redrawn version of FIG. 20 so that the ten Nodes are shown connected between pairs of Point Mesh modes. From this it is easier to envisage a practical geographical spread of the 10 Nodes and that that they can be connected to two Point Mesh nodes which are not too far away, although they may not be the nearest.

A larger form of the style of network shown in FIGS. 17 to 19 is shown in FIG. 22, but where for simplicity each six node mesh is drawn as a curved line, each line representing a complete Mesh of fifteen links between six Nodes: there being seven such curved lines representing the seven meshes. The twenty-one node FLAT network is based on a Strongly Regular Graph.

FIG. 23 shows the seven meshes as seven Point Meshes (A to G), with each node connected to two Point Meshes. This like FIG. 21 offers quite a regular way of connecting the twenty-one nodes to the seven Point Meshes.

There are other Strongly Regular Graphs which can be formed from several small meshes. FIG. 24 is formed from eight meshes each of four Nodes: four horizontal and four vertical, each complete horizontal or vertical line representing a complete Mesh of six Links between four Nodes. FIG. 25 shows the eight meshes as Point Meshes, with each node connected to just two Point Meshes, each un-numbered node representing a Point Mesh of six Links between four Nodes.

A more heavily interconnected network is shown in FIG. 26. This time lines are used to represent each mesh of which there are now twelve because in addition to the horizontal and verticals there are also four diagonal ones, each complete horizontal, vertical, or diagonal line representing a complete Mesh of six Links between four Nodes. FIG. 27 shows the network drawn with Point Meshes instead of lines. In this case each numbered node is connected to three Point Meshes, each un-numbered node representing a Point Mesh of six Links between four Nodes.

The Partially Interconnected FLAT Network examples, with Point Meshes, can be operated using the PTO method in two ways which are similar to the two ways described for the Partially Interconnected STAR Network shown in FIG. 10. FIG. 28 is a highlighted version of FIG. 23 and shows the four ways of establishing a path from Node 1 to Node 2. Node 1 and Node 2 are not connected to a common Point Mesh, so another node will have to be traversed.

The four options to reach Node 2 from Node 1 are: Point Mesh E (1-5-9-11-20-21) to Node 5 to Point Mesh B (2-5-8-13-17-18) Point Mesh A (14-12-14-16-17) to Node 12 to Point Mesh F (2-6-10-12-15-21) Point Mesh A (1-4-12-14-16-17) to Node 17 to Point Mesh B (2-5-8-13-17-18) Point Mesh E (1-5-9-11-20-21 to Node 21 to Point Mesh F (2-6-10-12-15-21)

For the combined MP and STC mode of operation, the Point Meshes can be fixed connection devices and one of the Nodes 5, 12, 17, 21 acts as the Simple Transit Core Node for the connection between Node 1 and Node 2. In general a Node can be an Originating MP Node, a Terminating MP Node and an STC Node.

The other method is that all the Point Mesh nodes are Simple Transit Core nodes and the other nodes are all MP Nodes.

By examining the four routing alternatives above which pass via nodes 5, 12, 17 or 21, even if one of the Point Meshes is unavailable it is still possible to find two valid Routes.

Also in FIG. 29 when trying to reach a node that is connected to the same Point Mesh and that Point Mesh is unavailable there is also an alternative path. For example for reaching from Node 1 to Node 4, but Point Mesh A (1-4-12-14-16-17) is unavailable, then it is still possible to go via: Point Mesh E (1-5-9-11-20-21) to Node 20 to Point Mesh D (4-7-8-10-19-20).

This resilience characteristic is a very useful feature of these types of networks. A similar characteristic applies for the Partially Interconnected STAR Network shown in FIG. 10 because the two halves of a Split AREA are independent of each other.

Not all Strongly Regular Graphs are suitable for efficient network applications. Ideally C8should equate to the appropriate number of CHOICEs required and C8 should if possible be similar to or smaller than C:

Strongly Regular Graphs can be used to form what can be called a FLAT Network. All the nodes have a similar status (e.g. they are not classified into different classes such as trunks and locals).

Each node in the FLAT Network needs to be able to establish individual circuits to the other Nodes, but in a Partially Interconnected FLAT network the Nodes are only connected to some of the other nodes. Consequently traffic has to transit through one of the other Nodes to make a connection.

As has already be mentioned trying to minimise the amount of call processing (or other processing) needed at a Simple Transit Core node can be very worthwhile. By using the PTO method at all the nodes of a Flat Network, then although call processing may be needed for the originating and terminating traffic, it will not be required for the transiting traffic.

Consequently, if a node is limited, by its call processing, or processing capabilities, but has plenty of raw switching capacity, then by employing the PTO method for the transiting function in a FLAT Network then all the nodes can be concerned with the processing of the originating and terminating traffic whilst the Simple Transiting function in the main only uses switching capacity and not the limited call processing or processing capacity.

A version of the five CHOICE pattern with one hundred and seventy-five AREAs and one hundred and seventy-five STARs mentioned earlier can also be a Strongly Regular Graph. This would enable a one hundred and seventy-five node Flat network to be constructed where each node is connected to thirty other nodes, with both C8 and C: equal to five.

This particular pattern will be used to consider the possibilities of using a Signalling Transfer Point function in conjunction with each Simple Transit Core (STC) node, for both the STAR and the FLAT type network.

Firstly for the Partially Interconnected STAR Network case:—As before assuming an average of forty Allocated MP nodes per Area and each allocated MP node in each AREA being connected to thirty STC STARs. Then the number of signalling links that have to be catered for is forty times twenty-nine namely one thousand one hundred and sixty. However if each STC STAR had an associated Signalling Transfer Point (e.g. a CCITT No. 7 Signalling Message Switch), then the number of signalling links from each allocated MP node would change considerably. The Signalling Transfer Point Message Switch at an STC STAR, in this case, would require one thousand one hundred and sixty ports, but the Allocated MP nodes would only need to handle thirty signalling channels although it would still be able to send and receive signalling to one thousand one hundred and sixty MP nodes from each of its thirty signalling channels, by adding the appropriate signalling point codes to the signalling messages so that the Signalling Transfer Point Message Switches can forward the signalling.

Consequently, the Partially Interconnected STAR Network topology can also be used for an associated signalling network.

Secondly, for the Partially Interconnected FLAT Network case, the one hundred and seventy-five combined STC STARS and MP nodes could each have an associated Signalling Transfer Point Message Switch. In this case each STC node function would need a thirty port Signalling Transfer Point Message Switch. Consequently the Partially Interconnected FLAT Network topology can also be used for an associated signalling network.

Depending on the type of network and the type of signalling terminations used, the use of Signalling Transfer Point Message Switches may have a considerable benefit.

It is important to note that for both the STAR and the FLAT forms of Partially Interconnected Networks that have been described herein that it is possible to construct regular networks where out of five Nodes or sites traversed that either one or two STC Nodes are included. A simple summary is shown below:

For Partially Interconnected STARs Networks (as Shown in FIG. 10):

| Allocated Node | Split AREA | STAR | Split AREA | Allocated Node |
|---|---|---|---|---|
| MP | Crossconnect | STC | Crossconnect | MP |
| MP | STC | MP | STC | MP |

For Partially Interconnected FLATs Networks (as Shown in FIG. 28 with One of 4 CHOICEs of Path from Numbered Node 1 to Numbered Node 2):

| MP/STC | Point Mesh | MP/STC | Point Mesh | MP/STC |
|---|---|---|---|---|
| MP | Crossconnect | STC | Crossconnect | MP |
| MP | STC | MP | STC | MP |

For both STAR and FLAT networks the types of Node traversed can be exactly the same.

For each Simple Transit Core Node the functional nodes (not basic crossconnects) to which it is connected must be Main Processing Nodes with Single Link Interfaces for each connection.

The combination of the PTO techniques and either the Partially Interconnected STAR Networks or Partially Interconnected FLAT Networks enables very efficient network architectures to be realised.

1-13. (canceled)

14. A partially interconnected network, comprising: a plurality of nodes, including one of Allocated Nodes and Star Nodes (STARs) and at least six Topological Nodes, wherein the Allocated Nodes are each allocated to one of a number of Areas (AREAs), wherein there are point-to-point interconnections between the Allocated Nodes and the STARs, wherein a number of AREAs with Allocated Nodes interconnected to an individual one of the STARs forms a number of Routes from an individual STAR, wherein the Allocated Nodes of a first of the AREAs are interconnected to a set comprising some, but not all, of the STARs, wherein further of the AREAs are similarly interconnected to further sets each comprising STARs, wherein there is at least one interconnection choice (Choice) between any two Allocated Nodes in different AREAs, wherein an interconnection route comprises two point-to-point interconnections interconnected in series by a STAR, wherein one of the Topological Nodes is selected from a single Physical Node, a group of interconnected Physical Nodes, a part of a Physical Node or a group of interconnected Physical Nodes, and parts of Physical Nodes, each Topological Node having at least three point-to-point Topological Links connecting the respective Topological Node to some, but not all, of the Topological Nodes, wherein there is at least one Choice of routing between any two Topological Nodes, wherein a Choice of routing comprises either two point-to-point Topological Links connected in series at another of the Topological Nodes or a direct point-to-point Topological Link between the two Topological Nodes, wherein at least one of the plurality of nodes includes a switching means for carrying out a Simple Transit Core Function, wherein at least three of the plurality of nodes include a Single Link Interface having associated Output Attributes and Input Cognizant Attributes, wherein each Simple Transit Core Function at one node is not logically connected to another Simple Transit Core Function at another node, wherein each Simple Transit Core Function at one node is logically connected to at least three Single Link Interfaces at other nodes, and wherein the nodes including Single Link Interfaces which are connected to one instance of a node arranged to carry out a Simple Transit Core Function are controlled by respective Intercommunicating Connection Acceptance Control Processes according to the respective Output Attributes and Input Cognizant Attributes.

15. The partially interconnected network as claimed in claim 14, wherein there are an equal number of Choices of interconnection Routes between any two Allocated Nodes in different AREAs and an equal number of Routes from each STAR.

16. The partially interconnected network as claimed in claim 14, wherein a network of the Topological Nodes is arranged by application of Strongly Regular Graphs.

17. The partially interconnected network as claimed in claim 14, wherein at least one STAR includes a Simple Transit Core Function, and wherein at least three Allocated Nodes each includes at least one Single Link Interface.

18. The partially interconnected network as claimed in claim 17, wherein the network also includes additional nodes, the additional nodes being AREA Nodes, and wherein switching functionality associated with a respective AREA Node is a fixed cross-connect function.

19. The partially interconnected network as claimed in claim 14, wherein three of the nodes comprise STARs and/or the Allocated Nodes, wherein the at least three nodes each includes at least one Single Link Interface, and wherein the network also includes additional nodes, the additional nodes being AREA Nodes, and wherein at least one of the AREA Nodes includes a Simple Transit Core Function.

20. The partially interconnected network as claimed in claim 14, wherein at least one of the Topological Nodes includes a Simple Transit Core function, and wherein at least three of the Topological Nodes each includes at least one Single Link Interface.

21. The partially interconnected network as claimed in claim 20, wherein at least one of the Topological Nodes includes a Simple Transit Core Function and at least one Single Link Interface.

22. The partially interconnected network as claimed in claim 20, wherein the network also includes additional nodes, the additional nodes being Point Mesh Nodes, and wherein switching functionality associated with the Point Mesh Nodes is a fixed cross-connect function.

23. The partially interconnected network as claimed in claim 22, where each Point Mesh Node is an Optical Wavestar.

24. The partially interconnected network as claimed in claim 22, where each Point Mesh Node comprises a distributed ring system.

25. The partially interconnected network as claimed in claim 20, wherein at least three of the Topological Nodes each includes at least one Single Link Interface, and wherein the network also includes additional nodes, the additional nodes being Point Mesh Nodes, and wherein at least one of the Point Mesh Nodes includes a Simple Transit Core Function.

26. The partially interconnected network as claimed in claim 14, wherein any node including a Simple Transit Core Function also includes a Signalling Transfer Point function.
